(19) United States
(12) Patent Application Publication
(10) Pub. No.: US 2013/0183491 A1
(43) Pub. Date: Jul. 18, 2013

(54) METHOD FOR FORMING FILM, AND FILM

(71) Applicants: Michinori Fujisawa, Okayama-shi (JP); Tomoaki Kimura, Okayama-shi (JP)

(72) Inventors: Michinori Fujisawa, Okayama-shi (JP); Tomoaki Kimura, Okayama-shi (JP)

(73) Assignee: KURARAY CO., LTD., Kurashiki-shi (JP)

(21) Appl. No.: 13/809,481

(22) PCT Filed: Jul. 5, 2011
(86) PCT No.: PCT/JP2011/065405

§ 371 Date: Mar. 22, 2013

(30) Foreign Application Priority Data
Jul. 12, 2010 (JP) 2010-158179
Sep. 21, 2010 (JP) 2010-211202

(51) Int. Cl. B05D 3/02

(52) U.S. Cl. CPC B05D 3/0254
USPC 428/141; 427/379; 428/219; 428/221; 428/315.7; 524/421

(57) ABSTRACT

A method for forming a film, containing the following steps (1) to (4), and a film obtained by the method for forming a film: step (1): preparing an aqueous dispersion liquid containing (A) a hydrophilic functional group-containing resin, (B) an ammonium salt, and (C) a nonionic thickener, a mixed amount of the component (B) being from 0.25 to 10 parts by mass per 100 parts by mass of a solid content of the component (A); step (2): coating the aqueous dispersion liquid on at least one surface of a substrate to form a coated film; step (3): subjecting the coated film to a thermal gelation treatment to form a gelled film; and step (4): drying and solidifying the gelled film to form a film.

### TECHNICAL FIELD

The present invention relates to a method for forming a film, a film, and a sheet article having the film formed thereon.

### BACKGROUND ART

A film has been formed on a substrate for imparting smoothness, cushioning property, physical strength and the like to the substrate. The film is formed by coating a dispersion liquid on the substrate, and an organic solvent, such as dimethylformamide (DMF), has been used as a solvent of the dispersion liquid coated on the substrate. However, many examples of the organic solvent, such as DMF, are highly flammable and highly toxic, and thus there are issues in danger of fire, deterioration of the working environment, pollution of the air and water, and the like. Furthermore, a film formed by using an organic solvent as the solvent may contain the organic solvent remaining, which causes an adverse influence to the human body on contact with the skin. Even through a step of recovering the remaining organic solvent is incorporated for solving these problems, other problems may occur due to increased disposal cost and labor cost.

Accordingly, formation of a film by using an aqueous emulsion resin without use of an organic solvent has been investigated.

Patent Document 1 aims to provide a sheet structure capable of producing an artificial leather excellent in air permeability without use of an organic solvent, such as DMF, and discloses a method for producing a sheet structure, in which a compound liquid formed by foaming an emulsion containing a base resin is continuously coated to a prescribed thickness on a substrate, only the surface thereof is dried by irradiating with a far infrared ray to form a thin dried film, and then the coated liquid is dried with hot air.

Patent Document 2 aims to provide an artificial leather excellent in air permeability and moisture permeability, and discloses a method for producing an artificial leather, in which an elastic polymer liquid containing mainly a polyurethane resin liquid in the form of an aqueous emulsion is coated to a thin film to form a film on a substrate, and the film is heat-treated by using a combination of wet heat and microwave, and then subjected to hot air drying and heat pressure molding.

Patent Document 3 discloses a polyurethane foamed article obtained in such a manner that thermoexpandable plastic microballoons are added to a nonionic polyurethane emulsion, which is produced by using a nonionic surfactant having a clouding point of from 35 to 95° C. as an emulsifier to a hydrophobic polyurethane resin, and the emulsion is subjected to a foaming treatment in water or steam at a temperature of from 40 to 190° C.

Patent Document 4 discloses a porous sheet formed from an aqueous dispersion liquid that contains a polymer elastic material, water repellent particles and a crosslinking agent, and that does not form precipitates or the like and is not gelled. The porous sheet has a thickness of from 1-0 to 500 μm, contains thereinside micropores having an average pore diameter of from 1 to 20 μm in an amount of from 500 to 15,000 pores per cubic millimeter, and has a breaking strength of from 1 to 15 N/mm² and a breaking elongation of from 100 to 500%.

### RELATED ART DOCUMENTS

### Patent Documents

### Patent Document 1

JP-A-11-81155

### Patent Document 2

JP-A-2000-160484

### Patent Document 3

JP-B-6-60260

### Patent Document 4

Japanese Patent No. 3,796,573

### DISCLOSURE OF THE INVENTION

### Problems to be Solved by the Invention

However, the production methods of Patent Documents 1 and 2 have a problem that in the step of forming a film through drying and solidification, cracks and pinholes may be formed on the film surface, which may deteriorate the appearance of the film. The formation of cracks and pinholes may remarkably occur in the case where the drying temperature or the air flow amount is increased for enhancing the drying efficiency. For suppressing cracks and the like from being formed, it is necessary to set the drying temperature and the air flow amount low, and as a result, a prolonged period of time is required for the drying process, which disadvantageously deteriorates the total production efficiency. In the case where a foamed film having a large thickness is to be formed, in particular, the drying process may require a considerably long period of time, and thus the production efficiency is remarkably deteriorated.

Furthermore, when a nonwoven fabric formed of the film obtained by the production methods of Patent Documents 1 and 2 is subjected to a hydrothermal treatment for refining, there may be a problem that the film is broken through absorption of hot water.

In the production method of an artificial leather, moreover, the dispersion liquid, such as the compound liquid, is coated on the surface of the substrate, but the viscosity of the dispersion liquid may be lowered until the thermal gelation process thereof is completed, and the dispersion liquid may sink down into the substrate, thereby making it difficult to provide a thick film.

The polyurethane foamed article of Patent Document 3 uses a forcedly emulsified aqueous emulsion resin, and thus is insensitive to gelation in the thermal gelation process, and the formation of the film after the gelation tends to be insufficient. On forming a foamed article having a large thickness, cracks may be formed in the drying process. Furthermore, the microballoons are expanded simultaneously with the thermal gelation, and thus there may be a problem that the strength of the film thus formed is lowered, and the foamed state thereof is not uniform.

The aqueous dispersion liquid prepared in Patent Document 4 is not gelled, and when the temperature is quickly increased for enhancing the drying efficiency, cracks may be formed on the surface of the sheet. For suppressing the formation of cracks, it is necessary to increase the temperature stepwise in several stages, which may deteriorate the productivity.

Furthermore, when the foamed article and the porous sheet disclosed in Patent Documents 3 and 4 are subjected to a hydrothermal treatment for refining, there may be a problem that the film is broken through absorption of hot water, and the fine pores are collapsed. As described above, there has been no disclosure about a technique capable of producing a film having a large thickness and a large number of fine pores without deterioration of the productivity.

A first object of the present invention is to provide a method for forming a film that is capable of suppressing formation of cracks or the like on the film surface even when the drying efficiency is enhanced by increasing the drying temperature, the air flow amount or the like, and is capable of forming a thick film excellent in peeling strength and hot water resistance, and a film.

A second object of the present invention is to provide a film that contains a large number of micropores mixedly present without collapse even with a large thickness, has a light weight, is excellent in peeling strength and embossing property, and has a large thickness, a method for forming a film capable of forming the film on a substrate, and a sheet article containing the film formed on a substrate.

### Means for Solving the Problems

The present inventors have found that the first object may be achieved by the method for forming a film shown as the following item [1] and the film shown as the following item [2], in which an aqueous dispersion liquid containing (A) a hydrophilic functional group-containing resin, a particular amount of (B) an ammonium salt, and (C) a nonionic thickener is coated on a substrate to form a coated film, the coated film is subjected to a thermal gelation treatment to form a gelled film, and the gelled film is dried and solidified to form a film.

[1] A method for forming a film, containing the following steps (1) to (4):

step (1): preparing an aqueous dispersion liquid (I) containing (A) a hydrophilic functional group-containing resin, (B) an ammonium salt, and (C) a nonionic thickener, a mixed amount of the component (B) being from 0.25 to 10 parts by mass per 100 parts by mass of a solid content of the component (A);

step (2): coating the aqueous dispersion liquid (I) on at least one surface of a substrate to form a coated film;

step (3): subjecting the coated film to a thermal gelation treatment to form a gelled film; and

step (4): drying and solidifying the gelled film to form a film.

[2] A film that is obtained by the method for forming a film according to the item [1].

The present inventors have also found that the second object may be achieved by the film shown as the following item [3] or [4], the method for forming a film shown as the following item [5], and the sheet article shown as the following item [6].

[3] A film containing a polymer elastic material formed of a hydrophilic functional group-containing resin, and a supporting member, and having a thickness of from 100 to 800 μm and a density of from 0.40 to 0.90 g/cm³, micropores, which are formed as gaps among particles of the polymer elastic material after the particles are gelled with a particle form thereof maintained and are partially bonded to each other, and the supporting member having an average diameter of from 10 to 50 μm being mixedly present on a cross section in a thickness direction of the film, and an opening of the micropores formed on a surface of the film having a pore diameter of 5 μm or less.

[4] A film that is capable of being formed by thermal gelation and drying and solidification of polymer elastic material particles formed of a hydrophilic functional group-containing resin in an emulsion containing at least the polymer elastic material particles and a supporting member, and the film having micropores formed as gaps among the polymer elastic material particles and the supporting member, which are mixedly present, an opening of the micropores formed on a surface of the film having a pore diameter of 5 μm or less.

[5] A method for forming the film according to the item [3] or [4], containing the following steps (1) to (4): step (1): preparing an aqueous dispersion liquid (II) containing (A) a polymer elastic material formed of a hydrophilic functional group-containing resin, (B) an ammonium salt, (C) a nonionic thickener, and (E) a supporting member, a mixed amount of the component (B) being from 0.25 to 10 parts by mass per 100 parts by mass of a solid content of the component (A);

step (2): coating the aqueous dispersion liquid (II) on at least one surface of a substrate to form a coated film;

step (3): subjecting the coated film to a thermal gelation treatment to form a gelled film; and

step (4): drying and solidifying the gelled film to form a film.

[6] A sheet article containing a substrate and formed thereon the film according to the item [3] or [4].

### Advantages of the Invention

According to the method for forming a film as the first invention of the present invention, even when the drying efficiency is enhanced by increasing the drying temperature, the air flow amount or the like, formation of cracks or the like on the film surface may be suppressed, thereby enhancing considerably the total production efficiency, and a thick film may be formed irrespective of the substrate used. The film formed by the method for forming a film is excellent in peeling strength and hot water resistance.

The film as the second invention of the present invention contains a large number of micropores mixedly present without collapse even with a large thickness thereof of from 100 to 800 μm, has a light weight, and is excellent in peeling strength and embossing property. Furthermore, the method for forming a film that forms the film on a substrate forms the film of the second invention of the present invention with the excellent productivity maintained.

### BRIEF DESCRIPTION OF THE DRAWINGS

FIG. 1 is an electron micrograph of the cross section of the film in the thickness direction obtained in Example II-1.

FIG. 2 is an electron micrograph of the cross section of the film in the thickness direction obtained in Comparative Example II-2.

### BEST MODE FOR CARRYING OUT THE INVENTION

First Method for forming Film

The method for forming a film of the first invention of the present invention (which may be hereinafter referred to as the first method for forming a film) contains the following steps (1) to (4):

step (1): preparing an aqueous dispersion liquid (I) containing (A) a hydrophilic functional group-containing resin, (B) an ammonium salt, and (C) a nonionic thickener, a mixed amount of the component (B) being from 0.25 to 10 parts by mass per 100 parts by mass of a solid content of the component (A);

step (2): coating the aqueous dispersion liquid (I) on at least one surface of a substrate to form a coated film;

step (3): subjecting the coated film to a thermal gelation treatment to form a gelled film; and

step (4): drying and solidifying the gelled film to form a film.

The steps (1) to (4) of the first method for forming a film of the present invention and a film obtained by the first method for forming a film (which may be hereinafter referred to as the first film) will be described in detail below.

### Step (1): Preparation of Aqueous Dispersion Liquid (I)

This step is for preparing the aqueous dispersion liquid (I). The aqueous dispersion liquid (I) prepared in this step contains (A) a hydrophilic functional group-containing resin, (B) an ammonium salt, and (C) a nonionic thickener, and preferably contains, depending on necessity, (D) a crosslinking agent and other additives, such as a foaming agent.

The viscosity of the aqueous dispersion liquid (I) is maintained to the viscosity immediately after the preparation thereof or is increased until the thermal gelation process in the step (3) described later is completed. Specifically, the viscosity of the aqueous dispersion liquid (I) is maintained to a level equivalent to that immediately after the preparation during the temperature increase in the step (3), and when the temperature reaches the thermal solidification temperature of the aqueous dispersion liquid (I), the aqueous dispersion liquid (I) is gelled, and thus the viscosity is increased. Accordingly, it is considered that the aqueous dispersion liquid (I) coated is prevented from being sunk down into the substrate during the thermal gelation treatment irrespective of the substrate used, thereby forming a thick film.

The viscosity of the aqueous dispersion liquid (I) in the period of from the preparation thereof in the step (1) to the completion of the thermal gelation treatment in the step (3) is preferably from 10 to 100 Pa·s, more preferably from 20 to 80 Pa·s, and further preferably from 30 to 75 Pa·s, by measuring with a single cylinder rotation viscometer at 6 rotations per minute. When the viscosity is 10 Pa·s or more, the aqueous dispersion liquid may be prevented from being sunk down into the substrate irrespective of the kind of the substrate even when the temperature is increased for the thermal gelation treatment. When the viscosity is 100 Pa·s or less, the handleability thereof may be optimized.

### (A) Hydrophilic Functional Group-Containing Resin

The hydrophilic functional group-containing resin (A) used in the present invention may be a self-emulsifying aqueous emulsion resin that has a hydrophilic functional group and is capable of being emulsified without the use of an anionic or nonionic surfactant.

A forcedly emulsified aqueous emulsion resin, which requires the addition of a surfactant, is insensitive to gelation in the thermal gelation treatment, and the formation of the film after the gelation tends to be insufficient. In the case where a forcedly emulsified aqueous emulsion resin is used, it is necessary to perform the thermal gelation treatment and the drying and solidification at a low temperature over a prolonged period of time, and thus the production efficiency is considerably low. Furthermore, the use of a surfactant deteriorates the properties, such as the peeling strength to the substrate, of the film, and causes bleed of the surfactant on the film surface with the lapse of time, which disadvantageously deteriorates the appearance of the film surface.

On the other hand, the self-emulsifying aqueous emulsion resin is free of the aforementioned disadvantages and may perform the thermal gelation treatment and the drying and solidification at a high temperature within a short period of time, and thus the production efficiency is considerably enhanced. The film formed of the self-emulsifying aqueous emulsion resin has a low swelling ratio to hot water to provide excellent hot water resistance, and it is thus considered that the film is prevented from being broken in a hydrothermal treatment.

Examples of the hydrophilic functional group in the component (A) include a carboxyl group, a sulfonyl group and a quaternary ammonium group. The hydrophilic functional group may be used solely or as a combination of two or more kinds thereof.

Examples of the component (A) include a hydrophilic functional group-containing aqueous emulsion polyurethane resin, a hydrophilic functional group-containing aqueous emulsion polyacrylic resin, and a mixture of the polyurethane resin and the polyacrylic resin. Among these, a hydrophilic functional group-containing aqueous emulsion polyurethane resin is preferred from the standpoint of flexibility.

The synthesis method of the component (A) is not particularly limited, and examples thereof include such a method that (a) an organic diisocyanate, (b) a polyol and (c) a compound having a hydrophilic functional group and two or more active hydrogen atoms are reacted to provide a hydrophilic functional group-containing isocyanate group-terminated prepolymer, which is neutralized and self-emulsified in water, and then is subjected to chain extending reaction with (d) a chain extending agent.

Examples of the organic diisocyanate (a) used include an aliphatic diisocyanate, an alicyclic diisocyanate and an aromatic diisocyanate, which each have two isocyanate groups.

Specific examples of the component (a) include an aliphatic diisocyanate compound, such as hexamethylene diisocyanate and trimethylhexamethylene diisocyanate, an alicyclic diisocyanate compound, such as isophorone diisocyanate, hydrogenated xylylene diisocyanate, dicyclohexylmethane diisocyanate, norbornane diisocyanate and 1,3-bis(isocyanatomethyl)cyclohexane, and an aromatic diisocyanate compound, such as tolylene diisocyanate, diphenylmethane diisocyanate, naphthalene diisocyanate, tolidine diisocyanate, xylylene diisocyanate and tetramethylxylylene diisocyanate.

Examples of the component (a) used may further include other organic diisocyanate compounds than the aforementioned compounds such as an alkyl-substituted compound, an alkoxy-substituted compound, a nitro-substituted compound, a prepolymer type modified product with a polyhydric alcohol, a carbodiimide modified product, a urea modified product, a burette modified product and a dimer or trimer reaction product, of the aforementioned compounds. The component (a) may be used solely or as a combination of two or more kinds thereof.

Among these, an aliphatic diisocyanate compound and an alicyclic diisocyanate compound are preferred, and hexamethylene diisocyanate, isophorone diisocyanate, dicyclohexylmethane diisocyanate, norbornane diisocyanate and 1,3-bis(isocyanatomethyl)cyclohexane are more preferred, from the stand point of the yellowing resistance, the heat stability and the light stability of the resulting component (A) and the film thus formed.

The polyol (b) is not particularly limited as far as it has two or more hydroxyl groups, and examples thereof include a polyester polyol, a polycarbonate polyol and a polyether polyol, and also include a polyetherester polyol having an ether bond and an ester bond.

Examples of the polyester polyol include polyethylene adipate, polybutylene adipate, polyethylenebutyleneadipate, polyhexamethylene isophthalate adipate, polyethylene succinate, polybutylene succinate, polyethylene sebacate, polybutylene sebacate, poly-ε-caprolactonediol, poly(3-methyl-1,5-pentylene)adipate, a polycondensate of 1,6-hexanediol and a dimer acid, a copolycondensate of 1,6-hexanediol, adipic acid and a dimer acid, a polycondensate of nonanediol and a dimer acid, and a copolycondensate of ethylene glycol, adipic acid and a dimer acid.

Examples of the polycarbonate polyol include polytetramethylene carbonate diol, polyhexamethylene carbonate diol, poly-1,4-cyclohexanedimethylene carbonate diol and 1,6-hexanediol polycarbonate polyol.

Examples of the polyether polyol include a homopolymer, a block copolymer and a random copolymer of polyethylene glycol, polypropylene glycol and polytetramethylene glycol, and a random copolymer and a block copolymer of ethylene oxide and propylene oxide, and ethylene oxide and butylene oxide.

The component (b) may be used solely or as a combination of two or more kinds thereof.

Among these, a polycarbonate polyol and a polyether polyol are preferred since sufficient durability may be imparted to the substrate.

The component (b) preferably has an average molecular weight of from 500 to 5,000, and more preferably from 1,000 to 3,000.

Examples of the compound having a hydrophilic functional group and two or more active hydrogen atoms (c) include 2,2-dimethylollactic acid, 2,2-dimethylolpropionic acid, 2,2-dimethylolbutanoic acid, 2,2-dimethylolvaleric acid, 3,4-diaminobutanesulfonic acid and 3,6-diamino-2-toluenesulfonic acid.

Examples of the component (c) further include a polyester polyol having a pendant hydrophilic functional group, which is obtained by reacting a diol having a hydrophilic functional group, an aromatic dicarboxylic acid or an aromatic disulfonic acid, and an aliphatic dicarboxylic acid or an aliphatic disulfonic acid. In place of the diol having a hydrophilic functional group, a diol having no hydrophilic functional group may be mixed and reacted.

The component (c) may be used solely or as a combination of two or more kinds thereof.

The acid value of the component (A) may be controlled with the mixed amount of the component (c). The component (c) is preferably mixed in such an amount that provides an acid value of the component (A) of from 5 to 50 KOHmg/g, and more preferably from 10 to 40 KOHmg/g. When the acid value of the component (A) is 5 KOHmg/g or more, the resin may be excellent in mechanical stability and mixing stability with other components, and when the acid value of the component (A) is 50 KOHmg/g or less, the aqueous dispersion liquid having a suitable viscosity may be prepared, and it is also favorable for the water resistance of the resulting film. The acid value herein is a value that is measured according to JIS K5400 (hereinafter the same).

On synthesizing the isocyanate group-terminated prepolymer by reacting the components (a) to (c), a low molecular weight chain extending agent having two or more active hydrogen atoms may be used depending on necessity.

The molecular weight of the low molecular weight chain extending agent is preferably 400 or less, and more preferably 300 or less.

Specific examples of the low molecular weight chain extending agent include a low molecular weight polyhydric alcohol, such as ethylene glycol, propylene glycol, neopentyl glycol, 1,4-butanediol, 1,6-hexanediol, trimethylolpropane, pentaerythritol and sorbitol, and a low molecular weight polyamine, such as ethylenediamine, propylenediamine, hexamethylenediamine, diaminocyclohexylmethane, piperazine, 2-methylpiperazine, isophoronediamine, diethylenetriamine and triethylenetetramine.

The low molecular weight chain extending agent may be used solely or as a combination of two or more kinds thereof.

The synthesis method of the hydrophilic functional group-containing isocyanate group-terminated prepolymer is not particularly limited, and examples thereof include known methods, such as a so-called one-shot method including one stage and an isocyanate polyaddition reaction method including plural stages. The reaction temperature herein is preferably from 40 to 150° C.

On performing the reaction, a reaction catalyst may be added depending on necessity, such as dibutyltin dilaurate, stannous octoate, dibutyltin-2-ethylhexanoate, triethylamine, triethylenediamine and N-methylmorpholine.

As the neutralization method of the hydrophilic functional group-containing isocyanate group-terminated prepolymer, known methods may be appropriately performed before or after the preparation. The neutralizing agent used herein is not particularly limited, and examples thereof include an amine compound, such as trimethylamine, triethylamine, tri-n-propylamine, tributylamine, N-methyldiethanolamine, N,N-dimethylmonoethanolamine, N,N-diethylmonoethanolamine and triethanolamine, potassium hydroxide, sodium hydroxide and ammonia. Among these, a tertiary amine compound having no hydroxyl group, such as trimethylamine, triethylamine, tri-n-propylamine and tributylamine, is preferred.

An emulsifying apparatus that is used for self-emulsification in water after the neutralization is not particularly limited, and examples thereof include a Homomixer, a Homogenizer and a Disper. The self-emulsification is preferably performed without an emulsifier in water at a temperature of from room temperature to 40° C., thereby preventing the isocyanate group and water from being reacted with each other as much as possible. On performing the self-emulsification, a reaction inhibitor may be added depending on necessity, such as phosphoric acid, sodium dihydrogen phosphate, disodium hydrogen phosphate, p-toluenesulfonic acid, adipic acid and benzoyl chloride.

After performing the self-emulsification in water, the chain extending reaction is performed with the chain extending agent (d), thereby providing an aqueous dispersion liquid of the hydrophilic functional group-containing resin (A).

The chain extending agent (d) is preferably a polyamine compound having two or more amino groups and/or imino groups, and examples thereof include a diamine compound, such as ethylenediamine, propylenediamine, tetramethylenediamine, hexamethylenediamine, diaminocyclohexylmethane, piperazine, hydrazine, 2-methylpiperazine, isophoronediamine, norbornanediamine, diaminodiphenylmethane, tolylenediamine and xylylenediamine; a polyamine compound, such as diethylenetriamine, triethylenetetramine, tetraethylenepentamine, iminobispropylamine and tris(2-aminoethyl)amine; an amidoamine derived from diprimary amine and monocarboxylic acid; a water soluble amine derivative, such as a monoketimine of a diprimary amine; and a hydrazine derivative, such as oxalic acid dihydrazide, malonic acid dihydrazide, succinic acid dihydrazide, glutaric acid dihydrazide, adipic acid dihydrazide, sebacic acid dihydrazide, maleic acid dihydrazide, fumaric acid dihydrazide, itaconic acid dihydrazide, 1,1′-ethylenehydrazine, 1,1′-trimethylenehydrazine and 1,1′-(1,4-butylene)dihydrazine. The polyamine compound may be used solely or as a combination of two or more kinds thereof.

The chain extending reaction is preferably performed at a reaction temperature of from 20 to 40° C. over a reaction time of from 30 to 120 minutes.

The component (A) preferably has a 100% modulus of from 1 to 9 MPa, and more preferably from 2 to 6 MPa. When the 100% modulus is 1 MPa or more, a film excellent in wear resistance may be formed, and when it is 9 MPa or less, a film having soft texture may be obtained. In the present invention, the 100% modulus is a tensile stress (MPa) on elongating a #3 dumbbell specimen to a distance between the gauge lines by 100% (elongating twice), which means a value measured according to JIS K6251 (1993) (hereinafter the same).

The component (A) preferably has a content of the hydrophilic functional group of from 0.5 to 4.0% by mass, and more preferably from 1.0 to 2.0% by mass. When the content of the hydrophilic functional group is 0.5% by mass or more, the component (A) may have good storage stability, and when it is 4.0% by mass or less, the thermal gelation temperature may be within a suitable temperature range, and sufficient migration prevention effect may be obtained.

The component (A) is preferably stored in a self-emulsified state, and the pH value in this state is preferably from 7.0 to 9.0, and more preferably from 7.5 to 8.5. When the pH value is 7.0 or more, the component (A) may have good storage stability, and when the pH value is 9.0 or less, sufficient migration prevention effect may be obtained.

### (B) Ammonium Salt

The aqueous dispersion liquid (I) contains (B) an ammonium salt. The component (A) is a self-emulsifying aqueous emulsion resin and is gelled solely only at a relatively high temperature (approximately 90° C.), but the component (A) may be gelled at a temperature around 60° C. by adding the component (B).

In the present invention, the mixed amount of the component (B) in the aqueous dispersion liquid (I) is from 0.25 to 10 parts by mass, preferably from 0.5 to 9 parts by mass, and more preferably from 1 to 7 parts by mass, per 100 parts by mass of a solid content of the component (A). The mixed amount of the component (B) of less than 0.25 part by mass is not preferred since gelation by the thermal gelation treatment may not be achieved sufficiently. The mixed amount of the component (B) exceeding 10 parts by mass is not preferred since the properties of the resulting film, such as the peeling strength to the substrate, may be deteriorated, and fine cracks may be formed on the film surface in some cases.

Specific examples of the ammonium salt (B) include ammonium salts of hydrochloric acid, nitric acid, phosphoric acid, sulfuric acid and a carboxylic acid. Examples of the carboxylic acid include a saturated fatty acid, such as formic acid, acetic acid, propionic acid, butyric acid, valeric acid, caproic acid, capric acid and stearic acid; an unsaturated fatty acid, such as oleic acid and linoleic acid; an aromatic carboxylic acid, such as benzoic acid, phthalic acid, isophthalic acid and terephthalic acid; a saturated dicarboxylic acid, such as malic acid, citric acid, oxalic acid, malonic acid, succinic acid and adipic acid; an unsaturated dicarboxylic acid, such as fumaric acid and maleic acid; lactic acid, acrylic acid, polyacrylic acid, and polymaleic acid.

Among these, ammonium sulfate and an ammonium salt of a carboxylic acid having from 1 to 10 carbon atoms are preferred, and ammonium sulfate and an ammonium salt of a carboxylic acid having from 1 to 4 carbon atoms are more preferred, since the mixed liquid may have favorable impregnation property, migration of the component (A) in the drying process may be favorably prevented, and the ammonium salt may be easily removed through evaporation in the drying step or by water washing after drying and thus may not remain in the film. Commercially available products may be used as the ammonium salt (B).

On mixing the component (B) with the component (A) in the method for forming a film of the present invention, the component (B) may be mixed in the form of a solid (powder), but it is preferred that the component (B) is dissolved in water, and the component (B) in the form of an aqueous solution is mixed with the component (A) from the standpoint of maintenance of the stability of the emulsion liquid of the component (A). In this case, the aqueous solution containing the component (A) and the component (B) having been mixed with each other preferably has a pH value of from 7.0 to 9.0, and more preferably from 7.5 to 8.5. When the pH value is 7.0 or more, a deposited matter may be prevented from being formed on mixing with the component (A), and when the pH value is 9.0 or less, a sufficient migration prevention effect of the component (A) may be obtained.

### (C) Nonionic Thickener

The aqueous dispersion liquid (I) contains (C) a nonionic thickener. The thickener contained increases the viscosity of the aqueous dispersion liquid (I), thereby enabling formation of a uniform and thick film and suppressing cracks from occurring on the film surface in the step (4). In the present invention, furthermore, by using a nonionic thickener as the thickener, the viscosity of the film formed of the aqueous dispersion liquid (I) is maintained to the viscosity immediately after the coating thereof or is increased during the temperature increase in the thermal gelation treatment, and thereby the aqueous dispersion liquid (I) is prevented from sunk down into the substrate. Consequently, a thick film may be formed irrespective of the kind of the substrate used.

The nonionic thickener as the component (C) is preferably such a material that suffers small change in the thickening effect with respect to changes of the temperature and the pH value of the aqueous dispersion liquid caused in the process until the gelation of the film is completed through the addition of the component (B) and the thermal gelation treatment, and may be selected from an associative thickener and a water soluble polymer thickener.

Examples of the associative thickener include urethane associative thickeners disclosed in JP-A-54-80349, JP-A-58-213074, JP-A-60-49022, JP-B-52-25840, JP-A-9-67563, JP-A-9-71766 and the like; an associative thickener obtained by copolymerizing a nonionic urethane monomer disclosed in JP-A-62-292879 and JP-A-10-121030 as an associative monomer with another acrylic monomer; and an associative thickener having an aminoplast skeleton disclosed in WO9640815, and among these, ones having strong nonionic property are preferably used.

From the standpoint of the density of pores of the porous structure and the strength retention thereof, an associative thickener having a polyethylene glycol chain and a urethane bond in the molecular chain thereof is preferred among these. Examples of the commercially available product thereof include Neostecker S (produced by Nicca Chemical Co. Ltd.).

Examples of the water soluble polymer thickener include a cellulose derivative, such as methylcellulose, ethyl cellulose, hydroxyethyl cellulose, hydroxypropyl cellulose, methylhydroxypropyl cellulose and carboxymethyl cellulose; a starch derivative, such as soluble starch, carboxymethyl starch and methyl starch; an alginic acid compound, such as sodium alginate and alginic acid propylene glycol ester; a natural polysaccharide compound, such as guar gum, carrageenan, galactan, gum arabic, locust bean gum, quince seed, tragacanth gum, pectin, mannan, starch, xanthan gum, dextran, succinoglucan, curdlan, and hyaluronic acid and a salt thereof; a natural protein compound, such as casein, gelatin, collagen and albumin; a polyoxyalkylene nonionic polymer, such as polyalkylene glycol, polyoxyethylene glycol distearate ester, myristoyl polyoxyethylene stearyl ether, polyoxyethylene sorbitan triisostearate, polyoxyethylene methylglucose(mono, di or tri)laurate, polyoxyethylene methylglucose(mono, di or tri)myristate, polyoxyethylene methylglucose(mono, di or tri)palmitate, polyoxyethylene methylglucose(mono, di or tri)stearate, polyoxyethylene methylglucose(mono, di or tri)isostearate and polyoxyethylene methylglucose(mono, di or tri)oleate; a vinyl polymer, such as polyvinyl alcohol, polyvinylpyrrolidone, polyvinyl methyl ether, a carboxyvinyl polymer and sodium polyacrylate; and mixtures thereof, and among these, ones having strong nonionic property may be selected. Examples of the commercially available product thereof include HEC AX-15 (hydroxyethyl cellulose, produced by Sumitomo Seika Chemicals Co., Ltd.), Aron A-SOP (a sulfonic acid monomer copolymer type acrylic thickener, produced by Toagosei Co., Ltd.) and Kelzan (a polymer polysaccharide (xanthan gum), produced by Sansho Co., Ltd.).

In the case where the film is produced by using a water soluble polymer thickener, a washing step is preferably performed after forming the film for preventing bleed of the thickener in the film with the lapse of time and stickiness due to moisture absorption.

The nonionic thickener may be used solely or as a combination of two or more kinds thereof.

The mixed amount of the component (C) is preferably from 0.5 to 20 parts by mass, more preferably from 1 to 15 parts by mass, and further preferably from 1.5 to 10 parts by mass, per 100 parts by mass of the solid content of the component (A). When the mixed amount is 0.5 part by mass or more, the viscosity of the aqueous dispersion liquid (I) may be maintained to a sufficiently high level until the thermal gelation treatment is completed in the step (3), thereby forming a uniform and thick film. Furthermore, cracks may be suppressed from occurring on the film surface in the drying process. When the mixed amount is 20 parts by mass or less, the aqueous dispersion liquid (I) obtained may have a viscosity within a range that is optimum for handling.

### (D) Crosslinking Agent

The aqueous dispersion liquid (I) preferably contains (D) a crosslinking agent (which may be hereinafter referred to as a component (D)) that reacts with the hydrophilic functional group of the component (A), for forming a crosslinked structure enhancing the durability of the film and accelerating the curing for enhancing the production efficiency.

In view of the aforementioned points, the content of the component (D) is preferably 1.0 to 5.0 parts by mass, more preferably from 1.2 to 4.5 parts by mass, and further preferably from 1.5 to 4.0 parts by mass, per 100 parts by mass of the solid content of the component (A).

The component (D) is not particularly limited, and preferred examples thereof include an oxazoline crosslinking agent, an epoxy crosslinking agent, an isocyanate crosslinking agent and a carbodiimide crosslinking agent.

Examples of the oxazoline crosslinking agent include compounds having two or more oxazolinyl groups, for example, a copolymer of 2-isopropenyl-2-oxazoline, butyl acrylate and methylmethacrylate, a copolymer of 2-isopropenyl-2-oxazoline, ethyl acrylate and methyl methacrylate, a copolymer of 2-isopropenyl-2-oxazoline and styrene, a copolymer of 2-isopropenyl-2-oxazoline, styrene and acrylonitrile, and a copolymer of 2-isopropenyl-2-oxazoline, styrene, butyl acrylate and divinylbenzene.

Examples of the epoxy crosslinking agent include sorbitol polyglycidyl ether, sorbitan polyglycidyl ether, polyglycerol polyglycidyl ether, pentaerythritol polyglycidyl ether, diglycerol polyglycidyl ether, triglycidyl-tris(2-hydroxyethyl)isocyanurate, glycerol polyglycidyl ether, trimethylolpropane polyglycidyl ether, resorcin diglycidyl ether, neopentyl glycol diglycidyl ether, 1,6-hexanediol diglycidyl ether, ethylene glycol diglycidyl ether, diethylene glycol diglycidyl ether, polyethylene glycol diglycidyl ether, propylene glycol diglycidyl ether, dipropylene glycol diglycidyl ether, polypropylene glycol diglycidyl ether, polytetramethylene glycol glycidyl ether, adipic acid diglycidyl ester, o-phthalic acid diglycidyl ester, hydroquinone diglycidyl ether, bisphenol S diglycidyl ether, terephthalic acid diglycidyl ester and dibromoneopentyl glycol diglycidyl ether.

Examples of the isocyanate crosslinking agent include tolylene diisocyanate, diphenylmethane diisocyanate (MDI), liquid MDI, such as polyphenylpolymethyl polyisocyanate, crude MDI, hexamethylene diisocyanate, xylylene diisocyanate, tetramethylxylylene diisocyanate, hydrogenated diphenylmethane diisocyanate, isophorone diisocyanate, trimers of these compounds with an isocyanurate ring, and a compound obtained by protecting the isocyanate groups with a blocking agent, such as a trimethylolpropane adduct.

Examples of the carbodiimide crosslinking agent include a polycarbodiimide resin, which is obtained by reacting a polyisocyanate compound with a compound having one functional group capable of being reacted with an isocyanate group, such as a hydroxyl group or an amino group, in the presence of a carbodiimidation catalyst. Examples of the polyisocyanate compound include hexamethylene diisocyanate, hydrogenated xylylene diisocyanate, xylylene diisocyanate, norbornane diisocyanate and isophorone diisocyanate. Examples of the compound having one functional group capable of being reacted with an isocyanate group include a monoalkyl ether of polyethylene glycol, and a monoalkyl ether of a random or block copolymer of polyethylene glycol and polypropylene glycol.

The crosslinking agent may be used solely or as a combination of two or more kinds thereof.

### Other Additives

The aqueous dispersion liquid (I) may further contain various additives in such a range that does not impair the advantages of the present invention. Examples of the additives include a pigment, a dye, an auxiliary binder, a leveling agent, a thixotropy imparting agent, a defoaming agent, a filler, a foaming agent, a sedimentation preventing agent, an ultraviolet ray absorbent, an antioxidant, a thinning agent, a moistening agent and a coloration preventing agent. The additives may be used solely or as a combination of two or more kinds thereof. As having been described above, the aqueous dispersion liquid (I) of the present invention preferably does not contain a surfactant.

The aqueous dispersion liquid (I) used in the first method for forming a film preferably contains a foaming agent among the aforementioned additives. The addition of a foaming agent facilitates control of the foaming magnification (the ratio of the volume after foaming to the volume of the dispersion liquid). Examples of the foaming agent include ones that have been ordinarily used.

The addition amount of water in the aqueous dispersion liquid (I) of the present invention may be appropriately controlled for the solid content and the viscosity, thereby providing the intended viscosity. Specifically, the addition amount of water is preferably from 20 to 250 parts by mass, and more preferably from 30 to 200 parts by mass, per 100 parts by mass of the solid content of the aqueous dispersion liquid (1).

### Foaming Treatment

In the method for forming a film of the present invention, when the procedures of the steps (2) and later are performed after subjecting the prepared aqueous dispersion liquid (I) to a foaming treatment, a foamed film having a larger thickness may be obtained. Examples of the foamed film include a foamed film having a thickness of from 250 to 600 μm and a foam diameter of from 25 to 250 μm. In the method for forming a film of the present invention, cracks are prevented from being formed on the film surface even on increasing the temperature and the air flow amount, and thereby a thick foamed film having a thickness of from 250 to 600 μm may be formed without deterioration of the production efficiency due to the drying process.

The foaming magnification on performing the foaming step for the aqueous dispersion liquid (I) in the step (1) is preferably from 1.1 to 2.5 times, more preferably from 1.2 to 2.2 times, and further preferably from 1.3 to 2.0 times. When the foaming magnification is 1.1 times or more, the aqueous dispersion liquid (I) may be prevented from penetrating excessively into the interior of the substrate, thereby holding the aqueous dispersion liquid (I) in the vicinity of the surface of the substrate to form a foamed film having a sufficient thickness. When the foaming magnification is 2.5 times or less, a part of the aqueous dispersion liquid (I) penetrates into the interior of the substrate, thereby forming a film that has a sufficient peeling strength to the substrate.

The foaming magnification in the present invention means a value showing the magnification of the apparent volume of the foamed article obtained by hot air drying of the aqueous dispersion liquid containing the foaming agent, with respect to the volume of the same mass of the aqueous dispersion liquid containing no foaming agent (hereinafter the same).

The measure for performing the foaming treatment in the present invention is not particularly limited, and a dry foaming method, a mechanical foaming method or a combination thereof is preferably employed.

In the dry foaming method, a foaming agent is added to a resin used, thereby foaming the resin. Examples of the foaming agent include ammonium stearate, a metal salt of a higher fatty acid, expanded capsules containing a liquid low boiling point hydrocarbon enclosed with a thermoplastic polymer shell (for example, Matsumoto Microsphere, a trade mark, produced by Matsumoto Yushi-Seiyaku Corporation). The foaming agent may be used solely or as a combination of two or more kinds thereof.

In the dry foaming method, a foaming assistant, such as sodium dialkylsulfosuccinate, a foam stabilizer, such as an ammonium long-chain alkyl carboxylate, e.g., ammonium stearate, and the like may be added depending on necessity, in addition to the foaming agent.

In the mechanical foaming method, a resin is mechanically agitated to entrain air, thereby foaming the resin.

Among the measures for foaming, it is preferred to employ a combination of the dry foaming method and the mechanical foaming method, in which the foaming agent, the foaming assistant, the foam stabilizer and the like are added to the aqueous dispersion liquid (1), which is then mechanically agitated to entrain air, thereby foaming the aqueous dispersion liquid.

### Step (2): Formation of Coated Film

In this step, the aqueous dispersion liquid (I) prepared in the step (1) is coated on at least one surface of a substrate to form a coated film.

The coating method of the aqueous dispersion liquid (I) of the present invention to the substrate is not particularly limited, and examples thereof include such methods as dip coating, blade coating, air knife coating, rod coating, hydro-bar coating, transfer roll coating, reverse coating, gravure coating, die coating, curtain coating, spray coating, roll coating, cast coating and screen coating, by which the aqueous dispersion liquid is coated on a part or the whole of the substrate.

The substrate to be coated may be appropriately selected depending on the objects and the purposes. Examples of the substrate include release paper, natural fibers, such as cotton and linen, a synthetic resin, such as PET, nylon, polyethylene and polypropylene, synthetic fibers, a nonwoven fabric, a natural leather, a synthetic leather, an artificial leather, a substrate for an artificial leather, paper, synthetic rubber, natural rubber, a film, a sheet, a metal, wood, glass, ceramics, stone, and soil. A leather product, such as a bag, shoes and a ball, may be used as the substrate to be coated, for imparting smoothness, cushioning property and physical strength thereto.

Among the aforementioned substrates, a substrate for an artificial leather is preferred, and a hydrothermal extraction type sea-island fiber nonwoven fabric is more preferred. In the hydrothermal extraction type sea-island fiber nonwoven fabric, the sea-island fibers are finely thinned by a hydrothermal extraction treatment, and simultaneously the nonionic thickener used for forming the film may also be washed out thereby. The film obtained by the formation method of the present invention contains the hydrophilic functional group-containing resin (A), and therefore has a low swelling ratio in the hydrothermal treatment and is excellent in hot water resistance, thereby preventing breakage of the film due to hot water.

Examples of the polymer (i.e., the island component) constituting the ultrafine fibers of the sea-island fibers (ultrafine fiber-forming fibers) include at least polymer selected from a polyamide compound capable of being melt-spun, such as 6-nylon and 66-nylon, a polyester compound capable of being melt-spun, such as polyethylene terephthalate, polybutylene terephthalate, isophthalic acid-modified polyester and cation-dyeable modified polyethylene terephthalate, and a polyolefin compound, such as polypropylene.

It is important that the component to be removed by extraction (i.e., the sea component) is constituted by a water soluble polymer and is capable of being spun. For example, known polymers that can be extracted with water or an aqueous solvent may be used as the water soluble polymer, and a polyvinyl alcohol copolymer that is capable of being dissolved with an aqueous solvent is preferably used. The volume ratio of the sea component and the island component is preferably from 1/2 to 2/1, and the fineness of the ultrafine fibers after extracting the sea component is preferably from 0.01 to 0.0001 dtex in view of the texture and the fulfillment.

The sea-island fiber nonwoven fabric may be produced in such a manner that short fibers having a length of from 20 to 75 mm are formed into a short fiber web by a card method, and the web is entangled by needle punching or with a high-speed fluid, or may be produced in such a manner that the material is spun and simultaneously formed into a long fiber web by a direct method, such as a spunbond method, and the web is entangled by needle punching or with a high-speed fluid.

### Step (3): Formation of Gelled Film

In this step, the coated film formed on the substrate in the step (2) is subjected to a thermal gelation treatment to form a gelled film. By forming a gelled film by performing the thermal gelation treatment, cracks may be suppressed from occurring, as compared to the case where the water content is evaporated only through the drying process without gelation.

The thermal solidification temperature, at which the coated film is gelled, is preferably from 30 to 80° C., and more preferably from 40 to 70° C. The thermal solidification temperature herein is a temperature, at which the aqueous dispersion liquid or the coated film is gelled, and is a temperature, at which when 50 g of the aqueous dispersion liquid is placed in a 100 mL glass beaker, and the beaker is gradually heated in a hot water bath at 95° C. while the content thereof is stirred, the content loses fluidity and is solidified (hereinafter the same). When the thermal solidification temperature is 30° C. or more, the aqueous dispersion liquid may be prevented from being gelled under an atmosphere at summer temperature, and when it is 80° C. or less, the thermal gelation may occur sharply, and thus the migration prevention in the subsequent drying step may be sufficiently exhibited.

Examples of the thermal gelation treatment include a hydrothermal treatment and a heat treatment with an infrared ray, and a hydrothermal treatment with steam is preferred for providing a favorable gelled state. The hydrothermal treatment with steam may be performed by heating steam to a temperature that is not lower than the thermal solidification temperature of the aqueous dispersion liquid (I), and for performing the production more stably, the temperature of steam is preferably (thermal solidification temperature+10° C.) or more. The temperature of steam is specifically preferably from 40 to 140° C., and more preferably from 60 to 120° C.

The humidity where the hydrothermal treatment is performed with steam is preferably close to 100% as much as possible since the surface is suppressed from being dried. The treating time with steam is preferably from 5 seconds to 30 minutes, and more preferably from 10 seconds to 20 minutes, for forming the gelled film sufficient.

Other optional methods may be employed in combination with the hydrothermal treatment with steam. Examples of the optional methods include solidification methods with an infrared ray, an electromagnetic wave and a high frequency wave.

### Step (4): Formation of Film

In this step, the gelled film formed in the step (3) is dried and solidified to form a film. Examples of the method for drying and solidifying include such drying methods as hot air heating, infrared heating, electromagnetic wave heating, high frequency wave heating and cylinder heating. Among these, hot air drying is preferred from the standpoint of the running cost and the productivity in continuous production. The drying method may be employed solely or as a combination of two or more kinds thereof.

The drying temperature is preferably from 60 to 190° C., and more preferably from 80 to 150° C., for drying the gelled film sufficiently without degradation and deterioration of the film by heat, and for enhancing the drying efficiency. The treating time is preferably from 1 to 20 minutes, and more preferably from 2 to 5 minutes, from the standpoint of the sufficient drying and the productivity.

### Hydrothermal Extraction Treatment

In the case where a hydrothermal extraction type sea-island fiber nonwoven fabric is used as the substrate, the aqueous dispersion liquid (I) of the present invention may be coated on the nonwoven fabric having been subjected to the hydrothermal extraction treatment in advance, but in the first method for forming a film of the present invention, the film may be formed on the nonwoven fabric, which is then subjected to a hydrothermal extraction treatment to convert to an ultrafine fiber nonwoven fabric.

In the method of the hydrothermal extraction treatment, specifically, the sea component in the nonwoven fabric is dissolved and removed with hot water, thereby making the island component to remain in the form of ultrafine fibers. The removal of the sea component with hot water may be performed by a known method under known conditions that have been employed in the production of an artificial leather or the like.

### Film Formed by First Method for Forming Film

The film formed by the first method for forming a film of the present invention (i.e., the first film) may be a film with a large thickness having a surface with a uniform plane suppressed in crack formation. The thickness of the first film formed on a substrate may be approximately from 15 to 400 μm when the foaming treatment is not performed, and may be approximately from 250 to 600 μm when the foaming treatment is performed. In the first method for forming a film of the present invention, a film with a large thickness may be formed irrespective of the kind of the substrate used, and therefore, the thickness of the film formed on the substrate may be freely selected depending on the objects and the purposes. In the case where the foaming treatment is performed, the foam diameter of the first film (i.e., the foamed film) may be appropriately selected depending on the objects and the purposes, and is preferably from 5 to 250 μm.

### Second Invention: Film

The film as the second invention of the present invention (which may be hereinafter referred to as a second film), in view of the structure of the film itself, contains a polymer elastic material formed of a hydrophilic functional group-containing resin, and a supporting member, and has a thickness of from 100 to 800 μm and a density of from 0.40 to 0.90 g/cm³, in which micropores, which are formed as gaps among particles of the polymer elastic material after the particles are gelled with the particle form thereof maintained and are partially bonded to each other, and the supporting member having an average diameter of from 10 to 50 μm are mixedly present on the cross section in the thickness direction of the film, and an opening of the micropores formed on the surface of the film has a pore diameter of 5 μm or less.

The second film of present invention, in view of the formation process of the film, is capable of being formed by thermal gelation and drying and solidification of polymer elastic material particles formed of a hydrophilic functional group-containing resin in an emulsion containing at least the polymer elastic material particles and a supporting member, and the film has micropores formed as gaps among the polymer elastic material particles and the supporting member, which are mixedly present, in which an opening of the micropores formed on a surface of the film has a pore diameter of 5 μm or less.

In the present invention, the second film is defined in view of the structure of the film itself and the formation process of the film. These definitions are understood independently from each other on construing the technical scope of the invention, and one of the definitions is not limited by the other.

In the present invention, for the average diameter or the pore diameter of an object that may not have a diameter identified, the area or surface area of the object is obtained, and a circle equivalent diameter or a sphere equivalent diameter, which is a diameter of a circle or a sphere having the same area or surface area of the object, is designated as the diameters.

In general, particles of a polymer elastic material attract each other and aggregate along with the progress of gelation. The gaps among the particles are narrowed with the progress of the aggregation, and micropores are collapsed to form a solid film. When the thickness of the film is increased, even though micropores are formed once, the micropores thus formed are collapsed by the load, such as the weight of the coated film that is not yet gelled before solidification, and thus the extent of the solid nature of the film is increased. The solid film is inferior in light weight property, surface smoothness and embossing property.

However, the second film of the present invention contains the supporting member along with the polymer elastic material in the emulsion before gelation, and therefore, the particles of the polymer elastic material are gelled and formed into a film while maintaining the particle state thereof throughout the process of gelation, drying and solidification, and formation of the film. Accordingly, the gaps among the particles are not narrowed and collapsed, thereby forming micropores. Even when the thickness of the film is increased, the gaps among the particles are maintained, and micropores are stably formed in the film. While the cause of the phenomenon may not be clear, it is considered that the load applied to the coated film before gelation is absorbed by the supporting member, and the load applied to the particles of the polymer elastic material and the micropores during the formation process thereof is diminished.

Consequently, the second film of the present invention becomes a film containing a large number of micropores mixedly present therein owing to the supporting member contained, irrespective of the large thickness thereof, and thus is excellent in light weight property, surface smoothness and embossing property.

The supporting member used may be one formed of a thermoplastic resin having a hollow structure in the form of a hollow capsule or having a solid structure in the form of a solid bead, and one having a hollow structure is preferred for enhancing the light weight property. The shape of the supporting member is not particularly limited, and examples thereof include particle shapes, such as a spherical shape and an ellipsoidal shape.

The supporting member is preferably a thermoexpandable supporting member for forming stable micropores in the film. The thermoexpandable supporting member may be one that has been completed in expansion on mixing (i.e., an expanded supporting member) or one that is completed in expansion before reaching the temperature, at which the emulsion is thermally gelled.

The supporting member is preferably thermoexpandable capsules that are expanded under heat and have a hollow structure. The thermoexpandable capsules may be expanded capsules that have been completed in expansion on mixing or ones that are completed in expansion in the process where the temperature is increased to the temperature, at which the emulsion is thermally gelled.

Examples of the structure of the thermoexpandable capsules include minute hollow spheres having a shell formed of a thermoplastic resin, such as a vinylidene chloride-acrylonitrile copolymer, having enclosed and encapsulated therein an organic compound having a particular boiling point as an expanding agent. As the organic compound functioning as an expanding agent, such a compound is selected that is completed in expansion at a temperature lower than the temperature, at which the emulsion is thermally gelled. There are various grades for the thermoexpandable capsules depending on the polymer species, the thickness of the shell, the diameter of the balloons, and the like, and also depending on the form thereof, e.g., fine powder or a wet cake, from which the thermoexpandable capsules used may be selected. Examples of the commercially available product thereof include Matsumoto Microsphere, a trade mark, produced by Matsumoto Yushi-Seiyaku Corporation.

The size of the supporting member (which is the size in the maximum expanded state for the thermoexpandable supporting member, or the size on mixing for the expanded supporting member) is preferably from 10 to 50 μm, more preferably from 10 to 40 μm, further preferably from 10 to 30 μm, and still further preferably from 15 to 30 μm. When the size is 10 μm or more, the particle state of the polymer elastic material may be maintained, and the gap among the particles are not collapsed, thereby forming micropores after forming the film. When the size is 50 μm or less, the micropores formed through the thermal gelation may be prevented from being collapsed due to the load, such as the weight of the coated film that is not yet gelled before solidification.

After completing the thermal gelation and the drying and solidification of the emulsion, the supporting member is incorporated as a part of the second film of the present invention. In the case where the supporting member having a hollow structure is used, in particular, the second film has large pores having an average pore diameter of from 10 to 50 μm on the cross section in the thickness direction of the film, which are derived from the supporting member. The outer wall of the large pores is formed of the thermoplastic resin of the shell of the supporting member, and thus has no micropore.

The average pore diameter of the large pores is from 10 to 50 μm, and is preferably from 10 to 40 μm, more preferably from 10 to 30 μm, and further preferably from 15 to 30 μm, for forming the film having stable micropores mixedly present. The large pores are formed with the supporting member having a hollow structure, and thus the average pore size of the large pores depends on the size of the supporting member. Accordingly, the average pore diameter of the large pore may be controlled by selecting the size of the supporting member used.

The polymer elastic material forming the film of the present invention is formed of a hydrophilic functional group-containing resin. The hydrophilic functional group-containing resin is a self-emulsifying aqueous emulsion resin that has a hydrophilic functional group and is capable of being emulsified without the use of an anionic or nonionic surfactant, as similar to the resin used for forming the first film. The film formed of a self-emulsifying aqueous emulsion resin has a low swelling ratio to hot water to provide excellent hot water resistance, and thus breakage of the film may be prevented.

Examples of the hydrophilic functional group include a carboxyl group, a sulfonyl group and a quaternary ammonium group, as described above. Examples of the hydrophilic functional group-containing resin include the resin exemplified above, and a hydrophilic functional group-containing aqueous emulsion polyurethane resin is preferred from the standpoint of flexibility.

The hydrophilic functional group-containing resin before heating is present as polymer elastomer particles having a particle diameter of approximately from 0.05 to 0.5 μm in the emulsion.

The thickness of the film of present invention may be such a thickness that the micropores are liable to be collapsed on forming the micropores, which is larger than the ordinary thickness. The thickness of the film is from 100 to 800 μm, and is preferably from 200 μm or more, more preferably 300 μm or more, and further preferably 400 μm or more.

The density of the film is from 0.40 to 0.90 g/cm³, and is preferably from 0.42 to 0.80 g/cm³, and more preferably from 0.45 to 0.75 g/cm³.

In the film of the present invention, the pore diameter of the opening of the micropores formed on a surface of the film is 5 μm or less. The pore diameter of larger than 5 μm is not preferred since the peeling strength may be lowered, and the appearance of the surface, the transfer property of an emboss pattern and the embossing property are deteriorated. In view of these points, the pore diameter is preferably 4 μm or less, and more preferably 3 μm or less.

The surface roughness (Rz) of the film of the present invention is preferably 30 μm or less, more preferably 25 μm or less, and further preferably 20 μm or less. When the surface roughness (Rz) is 30 μm or less, a film excellent in surface smoothness may be obtained. The surface roughness (Rz) in the present invention means a value obtained according to JIS B0601 (2001) (hereinafter the same).

For providing the film having a surface roughness (Rz) of 30 μm or less, the size of the supporting member (which is the size in the maximum expanded state for the thermoexpandable supporting member, or the size on mixing for the expanded supporting member) is preferably 50 μm or less, more preferably 40 μm or less, and further preferably 30 μm or less.

The ratio of the large pores having a diameter exceeding 75 μm with respect to the total area on the cross section in the thickness direction of the film of the present invention is preferably 10% or less, more preferably 7% or less, and further preferably 5% or less. When the ratio is 10% or less, the surface roughness (Rz) of the film may be suppressed to 30 μm or less, thereby providing a film excellent in surface smoothness. The method of measuring the ratio is not particularly limited, and examples thereof include the method disclosed for Examples.

### Method for Forming Film for Second Film

The second film of the present invention may be obtained in the same manner as the first method for forming a film except that instead of the aqueous dispersion liquid (I) prepared in the step (1) of the first method for forming a film of the present invention, an aqueous dispersion liquid (II) that further contains (E) a supporting member is used.

Specifically, the method for forming a film for the second film of the present invention is preferably a method for forming a film containing the following steps (1) to (4) (which may be hereinafter referred to as the second method for forming a film):

step (1): preparing an aqueous dispersion liquid (II) containing (A) a polymer elastic material formed of a hydrophilic functional group-containing resin, (B) an ammonium salt, (C) a nonionic thickener, and (E) a supporting member, a mixed amount of the component (B) being from 0.25 to 10 parts by mass per 100 parts by mass of a solid content of the component (A);

step (2): coating the aqueous dispersion liquid (II) on at least one surface of a substrate to form a coated film;

step (3): subjecting the coated film to a thermal gelation treatment to form a gelled film; and

step (4): drying and solidifying the gelled film to form a film.

The steps of the second method for forming a film of the present invention will be described below, and the mixed components and the mixed amounts thereof in the aqueous dispersion liquid (II) prepared, the preferred conditions in the steps, and the like are the same as the first method for forming a film unless otherwise indicated.

### Step (1): Preparation of Aqueous Dispersion Liquid (II)

The aqueous dispersion liquid (II) is formed by further adding the supporting member (E) to the aqueous dispersion liquid (I). Thus, the aqueous dispersion liquid (II) prepared in this step contains (A) a polymer elastic material formed of a hydrophilic functional group-containing resin, (B) an ammonium salt, (C) a nonionic thickener, and (E) a supporting member. The aqueous dispersion liquid (II) preferably contains, depending on necessity, (D) a crosslinking agent and other additives.

The viscosity of the aqueous dispersion liquid (II) is maintained to the viscosity immediately after the preparation thereof or is increased until the thermal gelation process in the step (3) described later is completed. Accordingly, decrease of the viscosity may not occur on heating, and the aqueous dispersion liquid is prevented from being sunk down into the substrate.

The viscosity of the aqueous dispersion liquid (II) in the period of from the preparation thereof in the step (1) to the completion of the thermal gelation treatment in the step (3) is preferably from 10 to 100 Pa·s, more preferably from 20 to 80 Pa·s, and further preferably from 30 to 75 Pa·s, by measuring with a single cylinder rotation viscometer at 6 rotations per minute, from the standpoint of preventing the aqueous dispersion liquid from being sunk down into the substrate, and the handleability thereof.

### Component (A): Polymer Elastic Material Formed of Hydrophilic Functional Group-Containing Resin

The polymer elastic material used in the present invention is formed of a hydrophilic functional group-containing resin, which is a self-emulsifying aqueous emulsion resin that has a hydrophilic functional group. Examples of the hydrophilic functional group-containing resin include those exemplified above.

The synthesis method of the hydrophilic functional group-containing resin may be the same as in the first method for forming a film described above, and for example, it may be synthesized in such a method that (a) an organic diisocyanate, (b) a polyol and (c) a compound having a hydrophilic functional group and two or more active hydrogen atoms are reacted to provide a hydrophilic functional group-containing isocyanate group-terminated prepolymer, which is neutralized and self-emulsified in water, and then is subjected to chain extending reaction with (d) a chain extending agent. Specific compounds for the components (a) to (d), preferred compounds, mixed amounts and synthesis methods therefor may be the same as those described for the first method for forming a film.

The component (A) preferably has a 100% modulus of from 1 to 9 MPa, and more preferably from 2 to 6 MPa.

The component (A) preferably has a content of the hydrophilic functional group of from 0.5 to 4.0% by mass, and more preferably from 1.0 to 2.0% by mass. The component (A) is preferably stored in a self-emulsified state, and the pH value in this state is preferably from 7.0 to 9.0, and more preferably from 7.5 to 8.5.

### Component (B): Ammonium Salt

In the second method for forming a film, an ammonium salt as a component (B) is added, and thereby the component (A) having a thermal gelation temperature of approximately 90° C. or more may be gelled at a temperature around 60° C. The mixed amount of the component (B) is preferably from 0.25 to 10.0 parts by mass, more preferably from 0.5 to 9.0 parts by mass, and further preferably from 1.0 to 7.0 parts by mass, per 100 parts by mass of a solid content of the component (A) in view of gelation by the thermal gelation treatment sufficiently and suppressing cracks from occurring on the film surface and peeling strength to the substrate sufficiently.

Examples of the component (B) include the ammonium salts described above, and ammonium sulfate and an ammonium salt of a carboxylic acid having from 1 to 10 carbon atoms are preferred, with ammonium sulfate and an ammonium salt of a carboxylic acid having from 1 to 4 carbon atoms being more preferred.

In the second method for forming a film, on mixing the component (B) with the component (A), the component (B) may be mixed in the form of a solid (powder), but it is preferred that the component (B) is dissolved in water, and the component (B) in the form of an aqueous solution is mixed with the component (A) from the standpoint of maintenance of the stability of the emulsion liquid of the component (A). In this case, the aqueous solution containing the component (B) preferably has a pH value of from 7.0 to 9.0, and more preferably from 7.5 to 8.5, for preventing a deposited matter from being formed on mixing, and achieving a sufficient migration prevention effect.

### Component (C): Nonionic Thickener

The use of the thickener increases the viscosity of the aqueous dispersion liquid, thereby enabling formation of a uniform and thick film and suppressing cracks from occurring on the film surface in the step (4). The thickener is preferably a nonionic thickener. By using a nonionic thickener, the viscosity of the film formed of the aqueous dispersion liquid is maintained to the viscosity immediately after the coating thereof or is increased during the temperature increase in the thermal gelation treatment, and thereby the aqueous dispersion liquid is prevented from sunk down into the substrate. Consequently, a thick film may be formed irrespective of the kind of the substrate used.

The nonionic thickener is preferably such a material that suffers small change in the thickening effect with respect to changes of the temperature and the pH value of the aqueous dispersion liquid caused in the process until the gelation of the film is completed through the addition of the component (B) and the thermal gelation treatment, and may be selected from the associative thickeners and the water soluble polymer thickeners described above, and ones having strong nonionic property are preferably used.

The associative thickener is more preferably such an associative thickener that has a polyethylene glycol chain and a urethane bond in the molecular chain thereof.

In the case where the film is produced by using a water soluble polymer thickener, a washing step is preferably performed after forming the film for preventing bleed of the thickener in the film with the lapse of time and stickiness due to moisture absorption. The nonionic thickener may be used solely or as a combination of two or more kinds thereof.

The mixed amount of the component (C) is preferably from 0.5 to 20 parts by mass, more preferably from 1 to 15 parts by mass, and further preferably from 1.5 to 10 parts by mass, per 100 parts by mass of the solid content of the component (A). When the mixed amount is 0.5 part by mass or more, the viscosity of the aqueous dispersion liquid may be maintained to a sufficiently high level until the thermal gelation treatment is completed in the step (3), thereby forming a uniform and thick film. Furthermore, cracks may be suppressed from occurring on the film surface in the drying process. When the mixed amount is 20 parts by mass or less, the aqueous dispersion liquid obtained may have a viscosity within a range that is optimum for handling.

### Component (E): Supporting Member

In the second method for forming a film of present invention, as described above, by adding a supporting member to the aqueous dispersion liquid, the particles as the component (A) may be aggregated to form a film while maintaining the particle state thereof, and micropores may be formed from the gaps among the particles, after forming the film. Examples of the supporting member include those exemplified above, and thermoexpandable capsules, such as Matsumoto Microsphere, a trade mark, produced by Matsumoto Yushi-Seiyaku Corporation, are preferred.

The content of the supporting member (E) is preferably from 0.2 to 1.5, more preferably from 0.3 to 1.2, and further preferably from 0.5 to 1.0, with respect to the volume of the solid content of the component (A), from the standpoint of the balance between the light weight property and the film strength.

### Component (D): Crosslinking Agent

The aqueous dispersion liquid of the present invention preferably contains (D) a crosslinking agent that reacts with the hydrophilic functional group of the component (A), for forming a crosslinked structure enhancing the durability of the film and accelerating the curing for enhancing the production efficiency.

The content of the component (D) is preferably 1.0 to 5.0 parts by mass, more preferably from 1.2 to 4.5 parts by mass, and further preferably from 1.5 to 4.0 parts by mass, per 100 parts by mass of the solid content of the component (A), for enhancing the durability and the production efficiency of the film.

The component (D) is not particularly limited, examples thereof include those exemplified above, and preferably include an oxazoline crosslinking agent, an epoxy crosslinking agent, an isocyanate crosslinking agent and a carbodiimide crosslinking agent.

The crosslinking agent may be used solely or as a combination of two or more kinds thereof.

### Other Additives

The aqueous dispersion liquid (II) may further contain the various additives exemplified for the aqueous dispersion liquid (I), in such a range that does not impair the advantages of the present invention. The aqueous dispersion liquid (II) of the present invention preferably does not contain a surfactant.

The addition amount of water in the aqueous dispersion liquid (II) of the present invention may be appropriately controlled for the solid content and the viscosity, thereby providing the intended viscosity of the aqueous dispersion liquid. Specifically, the addition amount of water is preferably from 20 to 250 parts by mass, and more preferably from 30 to 200 parts by mass, per 100 parts by mass of the solid content of the aqueous dispersion liquid (II).

### Defoaming Treatment

As a measure for the defoaming treatment in the second method for forming a film of the present invention, it is preferred that no any measure is performed except for the use of the component (E) contained, from the standpoint of decreasing the surface roughness of the film surface and uniformity of foaming. The use of the supporting member as the component (E) contained enables formation of micropores, as described above.

However, there are cases where the aqueous dispersion liquid (II) in the step (1) is foamed through entrainment of air bubbles in the preparation process of the aqueous dispersion liquid (II), and thus there are cases where problems may occur that pinholes having a diameter exceeding 5 μm are formed on the film surface, the surface roughness (Rz) exceeds 30 μm, and large foamed pores other than those formed with the supporting member are formed randomly in the film, which deteriorates the smoothness due to depression defects occurring on embossing. For avoiding these problems, the aqueous dispersion liquid (II) is preferably further subjected to a defoaming treatment after the preparation thereof. The method of the defoaming treatment is not particularly limited, and a method of defoaming under reduced pressure is preferred from the standpoint of the productivity.

### Step (2): Formation of Coated Film

In this step, the aqueous dispersion liquid (II) prepared in the step (1) is coated on at least one surface of a substrate to form a coated film.

The coating method of the aqueous dispersion liquid (II) may be the coating methods described for the first method for forming a film. The substrate to be coated may also be the substrates described above, and a substrate for an artificial leather is preferred, with a hydrothermal extraction type sea-island fiber nonwoven fabric being more preferred. In the hydrothermal extraction type sea-island fiber nonwoven fabric, the sea-island fibers are finely thinned by a hydrothermal extraction treatment, and simultaneously the nonionic thickener used for forming the film may also be washed out thereby. The second film of the present invention contains the hydrophilic functional group-containing resin (A), and therefore has a low swelling ratio in the hydrothermal treatment and is excellent in hot water resistance, thereby preventing breakage of the film due to hot water.

Specific components for the polymer (i.e., the island component) constituting the ultrafine fibers of the sea-island fibers (ultrafine fiber-forming fibers) and the component to be removed by extraction (i.e., the sea component), the suitable volume ratio of the sea component and the island component, and the suitable fineness of the ultrafine fibers after extracting the sea component may be the same as described above.

### Step (3): Formation of Gelled Film

In this step, the coated film formed on the substrate in the step (2) is subjected to a thermal gelation treatment to form a gelled film. By forming a gelled film by performing the thermal gelation treatment, cracks may be suppressed from occurring, as compared to the case where the water content is evaporated only through the drying process without gelation. The thermal solidification temperature, at which the coated film is gelled, is preferably from 30 to 80° C., and more preferably from 40 to 70° C., from the standpoint of preventing the phenomenon that the aqueous dispersion liquid is gelled, making the thermal gelation to occur sharply, and exhibiting the migration prevention in the drying step sufficiently.

Examples of the thermal gelation treatment include the treatment methods described for the first method for forming a film described above, and a hydrothermal treatment with steam is preferred for providing a favorable gelled state. The hydrothermal treatment with steam may be performed by heating steam to a temperature that is not lower than the thermal solidification temperature of the aqueous dispersion liquid (II), and for performing the production more stably, the temperature of steam is preferably (thermal solidification temperature+10° C.) or more. The temperature of steam is specifically preferably from 40 to 140° C., and more preferably from 60 to 120° C.

The humidity where the hydrothermal treatment is performed with steam is preferably close to 100% as much as possible since the surface is suppressed from being dried. The treating time with steam is preferably from 5 seconds to 30 minutes, and more preferably from 10 seconds to 20 minutes, for forming the gelled film sufficient.

Other optional methods described above may be employed in combination with the hydrothermal treatment.

### Step (4): Formation of Film

In this step, the gelled film formed in the step (3) is dried and solidified to form a film. Examples of the method for drying and solidifying include the methods described for the first method for forming a film, and hot air drying preferred from the standpoint of the running cost and the productivity in continuous production.

The drying temperature is preferably from 60 to 190° C., and more preferably from 80 to 150° C., for drying the gelled film sufficiently without degradation and deterioration of the film by heat, and for enhancing the drying efficiency. The treating time is preferably from 1 to 20 minutes, and more preferably from 2 to 5 minutes, from the standpoint of the sufficient drying and the productivity.

### Hydrothermal Extraction Treatment

In the case where a hydrothermal extraction type sea-island fiber nonwoven fabric is used as the substrate, the aqueous dispersion liquid of the present invention may be coated on the nonwoven fabric having been subjected to the hydrothermal extraction treatment in advance, but in the present invention, the film may be formed on the nonwoven fabric, which is then subjected to a hydrothermal extraction treatment to convert to an ultrafine fiber nonwoven fabric.

The method of the hydrothermal extraction treatment and the method of removing the sea component with hot water may be the same as in the first method for forming a film.

### Sheet Article

A sheet article having the film of the present invention formed on a substrate has good light weight property and embossing property, has an excellent peeling strength, has a thick film having a large number of micropores mixedly present therein, and thus is suitable for such purposes as a vehicle interior material, furniture, clothing, shoes, bags, bag-like articles, sandals, groceries and the like.

In addition to the film, a colored layer that is ordinarily used in a sheet article, may be applied to the substrate, and embossed by a heat pressing method, thereby providing a sheet article having a colored layer. In this case, the thickness of the colored layer is not particularly limited, and is preferably 20 μm or less.

### EXAMPLE

The present invention will be described in more detail with reference to examples below, but the present invention is not limited to the examples.

### Example I-1

An aqueous dispersion liquid containing 250 parts by mass (solid content: 100 parts by mass) of (A) an aqueous emulsion of a carboxyl group-containing polyurethane resin (HA-10C, a trade name, produced by Nicca Chemical Co. Ltd., not gelled solely until 90° C., but gelled at 60° C. under addition of ammonium sulfate), 3.75 parts by mass (solid content) of (B) ammonium sulfate, 2.5 parts by mass (solid content) of (C) a nonionic thickener (Kelzan (xanthan gum), a trade name, produced by Sansho Co., Ltd.), 3.75 parts by mass (solid content) of (D) a crosslinking agent (NK Assist CI, a trade name, produced by Nicca Chemical Co. Ltd., carbodiimide crosslinking agent), and 2.0 parts by mass of (E) expanded capsules (Matsumoto Microsphere F-80SDE, a trade name, produced by Matsumoto Yushi-Seiyaku Corporation, expansion ratio: ca. 1.6) was prepared. The measurement of the viscosity at 25° C. and 60° C. of the aqueous dispersion liquid thus prepared revealed that the viscosity was 35 Pa·s at 25° C. and 42 Pa·s at 60° C., and thus the viscosity was increased on heating to the thermal solidification temperature, as compared to the viscosity immediately after the preparation thereof.

### Measurement of Viscosity of Aqueous Dispersion Liquid

The aqueous dispersion liquid thus prepared was measured for viscosity at 25° C. and 60° C. with a single cylinder rotation viscometer (Vismetron VG-A1, a trade name, produced by Shibaura System Co., Ltd.) at 6 rotations per minute.

The aqueous dispersion liquid thus prepared was coated by direct coating to a thickness of 830 μm on a nonwoven fabric, thereby providing a coated film. The coated film was subjected to a thermal gelation treatment with steam at 90° C. for 10 minutes at a relative humidity of 60%, thereby providing a gelled film. Thereafter, the gelled film was dried and solidified by hot air drying at 150° C. for 10 minutes, thereby providing a foamed film having a thickness of 400 μm and a foamed diameter of 30 μm. The surface of the foamed film had no crack or pinhole, and a uniform surface was obtained.

The resulting foamed film was observed for the state of gelation and the presence of cracks on the film surface, and also measured and evaluated for the following items (1) to (3). The results are shown in Table 1.

### (1) Measurement of Thickness of Foamed Film

The cross section in the thickness direction of the resulting film was observed with an electron microscope at a magnification of approximately 100 at five positions with a viewing field having a width of approximately 1 mm. The average value of the values of thickness measured at the positions was designated as the thickness of the film.

### (2) Measurement of Peeling Strength

A surface of a polyurethane rubber plate having a length of 15 cm, a width of 2.5 cm and a thickness of 5 mm was lightly scraped with sandpaper, on which a two-component crosslinking type polyurethane adhesive was coated uniformly from one end thereof to a range of a length of approximately 10 cm. Separately, to a test piece obtained by cutting a substrate for an artificial leather into a length of 25 cm and a width of 2.5 cm, the adhesive was similarly coated uniformly from one end thereof to a range of a length of approximately 10 cm, and was adhered to the rubber plate in such a manner that ends with the adhesive coated were overlapped each other. The test piece and the rubber plate thus adhered were pressed under a pressure of approximately from 2 to 4 kg/cm², and was allowed to stand at 25° C. for one day. The ends of the test piece and the rubber plate with no adhesive coated were set to upper and lower chucks of a tensile tester with an initial distance of 5 cm, and the peeling strength of the adhered portions of the rubber plate and the test piece corresponding to a tensile time at a tensile speed of 10 cm/min was measured and recorded on a chart. In a range of the tensile time-peeling strength curve obtained on the chart where the peeling strength was substantially constant, an average value was read and designated as the peeling strength of the test piece. Three test pieces cut out from arbitrary three positions of one kind of a substrate for an artificial leather were measured for the peeling strength measured values, and an arithmetic average value of the measured values was designated as the peeling strength of the substrate for an artificial leather.

(3) Measurement of Area Swelling Ratio and Mass Swelling Ratio with Hot Water

The aqueous dispersion liquid thus prepared was directly coated on a release paper and dried at 70° C. for 30 minutes, and then subjected to a heat treatment at 120° C. for 5 minutes, thereby forming a film having a thickness of 200 μm. The resulting film was immersed in hot water at 95° C. for 30 minutes, and the film was then taken out and, after wiping water on the surface, measured for the area swelling ratio and the mass swelling ratio.

### Comparative Examples I-1 and I-2

A nonwoven fabric having a foamed film was produced in the same process as in Example I-1 except that the compositions of the components (A) to (E) were changed to those shown in Table 1. The aqueous dispersion liquid was measured for viscosity, and the resulting foamed film was observed for the state of gelation and the presence or absence of cracks occurrence on the film surface, and also measured and evaluated for the following items (1) to (3). The results are shown in Table 1.

### Comparative Example I-3

A nonwoven fabric having a foamed film was produced in the same manner as in Example I-1 except that the thermal gelation treatment was not performed. The aqueous dispersion liquid was measured for viscosity, and the resulting foamed film was observed for the state of gelation and the presence or absence of cracks occurrence on the film surface, and also measured and evaluated for the following items (1) to (3). The results are shown in Table 1.

### Comparative Example I-4

A nonwoven fabric having a foamed film was produced in the same manner as in Example I-1 except that in the composition of the aqueous dispersion liquid prepared in Example I-1, the component (C) was changed to 5.0 parts by mass of Aron A-20P (an acrylic thickener, an anionic thickener, produced by Toagosei Co., Ltd.). The aqueous dispersion liquid was measured for viscosity, and the resulting foamed film was observed for the state of gelation and the presence or absence of cracks occurrence on the film surface, and also measured and evaluated for the following items (1) to (3). The results are shown in Table 1.

TABLE 1

| | | | | | | Comparative | Comparative | Comparative | Comparative |
|---|---|---|---|---|---|---|---|---|---|
| | | Composition | Trade name | Unit | Example I-1 | Example I-1 | Example I-2 | Example I-3 | Example I-4 |
| Composition | (A) | Aqueous | HA-10C | part | 250 | 250 | 250 | 250 | 250 |
| of dispersion | | emulsion resin | | by | solid content: | solid content: | solid content: | solid content: | solid content: |
| liquid | | | | mass | 100 | 100 | 100 | 100 | 100 |
| | (B) | Ammonium | ammonium | | 3.75 | 0.125 | 12.5 | 3.75 | 3.75 |
| | | salt | sulfate | | | | | | |
| | (C) | Thickener | Kelzan | | 2.5 | 2.5 | 2.5 | 2.5 | — |
| | | | Aron A-20P | | — | — | — | — | 5.0 |
| | (D) | Crosslinking | NK Assist Cl | | 3.75 | 3.75 | 3.75 | 3.75 | 3.75 |
| | | agent | | | | | | | |
| | | Foaming | Matsumoto | | 2.0 | 2.0 | 2.0 | 2.0 | 2.0 |
| | | agent | Microsphere | | | | | | |
| | | | F-80SDE | | | | | | |

| | | | | | | | |
|---|---|---|---|---|---|---|---|
| Viscocity of | 25° C., 6 rpm | Pa·s | 35 | 30 | 40 | 35 | 28 |
| dispersion liquid | 60° C., 6 rpm | | 42 | 28 | 100 | 42 | 2 |

| Presence of step (3) | | | — | present | present | present | none | present |
|---|---|---|---|---|---|---|---|---|
| (thermal gelation treatment) | | | | | | | | |
| Coated amount of | | | g/m² | 830 | 830 | 830 | 830 | 830 |
| dispersion liquid on substrate (wet) | | | | | | | | |
| Evaluation | State of gelation | | — | good | poor | good | poor | good |
| | Presence or absence of cracks | | — | good | cracks | fine cracks | cracks | good |
| | occurrence on film surface | | | | formed | formed | formed | |
| | (1) | Thickness of | μm | 400 | 280 | 400 | 300 | 150 |
| | | foamed film | | | | | | |
| | | formed on | | | | | | |
| | | substrate | | | | | | |
| | (2) | Peeling strength | kg/ | 8.0 | 8.0 | 5.0 | 8.0 | 4.5 |
| | | | 2.5 cm | | | | | |
| | (3) | Area swelling ratio | % | 3.0 | 3.0 | 3.0 | 3.0 | 3.0 |
| | | Mass swelling ratio | % | 5.0 | 8.5 | 1.0 | 5.0 | 5.0 |

The foamed film of Example I-1 had a good gelled state and had no crack formed on the film surface. The peeling strength of the foamed film had no problem. Furthermore, a foamed film having a thickness of 400 μm and a foam diameter of 30 μm was produced. Moreover, the foamed film was small in both the area swelling ratio and the mass swelling ratio to hot water, and thus it was found that the foamed film of Example I-1 had excellent hot water resistance.

The foamed film of Comparative Example I-1 had a small mixed amount of ammonium sulfate, and therefore the foamed film was not sufficiently gelled and had cracks formed on the film surface.

The foamed film of Comparative Example I-2 had a large mixed amount of ammonium sulfate, and therefore the foamed film had fine cracks formed on the film surface and was decreased in the peeling strength, thereby failing to provide a film with a sufficient physical strength.

The foamed film of Comparative Example I-3 was formed without the thermal gelation treatment performed, and therefore the foamed film was not sufficiently gelled and had cracks formed on the film surface.

The foamed film of Comparative Example I-4 used an anionic thickener instead, and therefore the viscosity of the aqueous dispersion was decreased from the coating until the thermal gelation treatment was completed, and the aqueous dispersion liquid was sunk down into the substrate, thereby forming a foamed film that had a small thickness of 150 μm formed on the substrate.

### Example II-1

### Production of Film

250 parts by mass (solid content: 100 parts by mass) of (A) an aqueous emulsion of a carboxyl group-containing polyurethane resin (HA-10C, a trade name, produced by Nicca Chemical Co. Ltd., not thermally-gelled solely until 90° C., but gelled at 60° C. under addition of ammonium sulfate), 5.0 parts by mass (solid content) of (B) ammonium sulfate, 1.5 parts by mass (solid content) of (C) a nonionic thickener (Kelzan (xanthan gum), a trade name, produced by Sansho Co., Ltd.), 3.75 parts by mass (solid content) of (D) a crosslinking agent (NK Assist CI, a trade name, produced by Nicca Chemical Co. Ltd.), and 2.0 parts by mass of expanded capsules having a particle diameter of 30 μm (Matsumoto Microsphere F-80SDE, a trade name, produced by Matsumoto Yushi-Seiyaku Corporation, expansion ratio: ca. 1.6) as (E) a supporting member were mixed, and subjected to a defoaming treatment under reduced pressure for removing air bubbles entrained in the mixing process, thereby providing an aqueous dispersion liquid. The aqueous dispersion liquid was coated by direct coating to a thickness of 800 μm (wet state before drying) on a nonwoven fabric, thereby providing a coated film.

The coated film was subjected to a thermal gelation treatment with steam at 90° C. under a relative humidity of 60% for 10 minutes, thereby providing a gelled film. Thereafter, the gelled film was dried and solidified with hot air at 150° C. for 10 minutes, thereby providing a foamed film. The surface of the foamed film did not have cracks and pinholes and constituted a uniform surface. The foamed film was measured and evaluated for the following items (1) to (8). The results are shown in Table 2.

### Evaluation Items for Resulting Film

### (1) Measurement of Thickness of Film

The cross section in the thickness direction of the resulting film was observed with an electron microscope at a magnification of approximately 100 at five positions with a viewing field having a width of approximately 1 mm. The average value of the values of thickness measured at the positions was designated as the thickness of the film.

### (2) Presence of Micropores on Cross Section of Film

The cross section in the thickness direction of the resulting film was observed with an electron microscope at a magnification of approximately from 1,000 to 2,000 for confirming the presence of micropores. For the average pore diameter of large pores, an average value of the largest 50 pores in major diameter was designated as the average pore diameter.

### (3) Measurement of Diameter of Pinholes on Film Surface

The surface of the resulting film was observed with an electron microscope at a magnification of approximately from 1,000 to 2,000, and major diameters of 50 pinholes were measured, and the average value thereof was designated as the diameter of pinholes.

### (4) Measurement of Density of Film

The aqueous dispersion liquid was coated on a nonwoven fabric and dried, and the attached amount of the solid matter after drying was divided by the volume of the film, which was calculated based on the thickness of the film measured in the item (2), to provide the density of the film.

### (5) Measurement of Surface Roughness of Film

The surface roughness (maximum height Rz) was measured according to JIS B0601 (2001) with a white interference microscope (New View 6000), produced by Zygo Corporation, with an objective lens of 2.5 times and a measured range of 2.82 mm×2.13 mm.

(6) Measurement of Proportion of Large Pores Exceeding 75 μm in Diameter with Respect to Total Area of Cross Section of Film

The cross section in the thickness direction of the resulting film was observed with an electron microscope at a magnification of approximately 100 at five positions with a viewing field having a width of approximately 1 mm, and the images were printed on photographic paper. From the photographic paper having the image printed thereon, the portion of the film was cut out and measured for the weight thereof, and then the portion with a major diameter exceeding 75 μm was cut out therefrom and measured for the weight thereof, from which the proportion of the large pores exceeding 75 μm in diameter was calculated.

### (7) Measurement of Peeling Strength

A surface of a polyurethane rubber plate having a length of 15 cm, a width of 2.5 cm and a thickness of 5 mm was lightly scraped with sandpaper, on which a two-component crosslinking type polyurethane adhesive was coated uniformly from one end thereof to a range of a length of approximately 10 cm. Separately, to a test piece obtained by cutting a substrate for an artificial leather into a length of 25 cm and a width of 2.5 cm, the adhesive was similarly coated uniformly from one end thereof to a range of a length of approximately 10 cm, and was adhered to the rubber plate in such a manner that ends with the adhesive coated were overlapped each other. The test piece and the rubber plate thus adhered were pressed under a pressure of approximately from 2 to 4 kg/cm², and was allowed to stand at 25° C. for one day. The ends of the test piece and the rubber plate with no adhesive coated were set to upper and lower chucks of a tensile tester with an initial distance of 5 cm, and the peeling strength of the adhered portions of the rubber plate and the test piece corresponding to a tensile time at a tensile speed of 10 cm/min was measured and recorded on a chart. In a range of the tensile time-peeling strength curve obtained on the chart where the peeling strength was substantially constant, an average value was read and designated as the peeling strength of the test piece. Three test pieces cut out from arbitrary positions of one kind of a substrate for an artificial leather were measured for the peeling strength measured values, and an arithmetic average value of the measured values was designated as the peeling strength of the substrate for an artificial leather.

### (8) Evaluation of Emboss Transfer Property

The foamed film was processed with an emboss roll having a roll diameter of 40 cm at a surface temperature of 160° C., a linear pressure of 10 kg/cm and a processing speed of 1 m/min, and the transferred state of the emboss was visually evaluated. As the emboss roll, an emboss roll (a) capable of transferring a skin pore emboss having a convex height of 45 μm and a diameter of 20 μm and an emboss roll (b) capable of transferring a relief pattern having a convex height of 200 μm and a diameter of 2 mm were used.

### Example II-2

A nonwoven fabric having a foamed film was produced in the same manner as in Example II-1 except that 2.0 parts by mass of expanded capsules having a particle diameter of 100 μm (Matsumoto Microsphere F-80DE, a trade name, produced by Matsumoto Yushi-Seiyaku Corporation, expansion ratio:ca. 1.6) was used as the supporting member (D). The foamed film was measured and evaluated for the items (1) to (8) in the same manner as in Example II-1. The results are shown in Table 2.

### Comparative Example II-1

A nonwoven fabric having a foamed film was produced in the same manner as in Example II-1 except that the supporting member (D) was not used. The foamed film was measured and evaluated for the items (1) to (8) in the same manner as in Example II-1. The results are shown in Table 2.

### Comparative Example II-2

A nonwoven fabric having a foamed film was produced in the same manner as in Example II-1 except that instead of the addition of the supporting member (D), 5 parts by mass of an ammonium stearate aqueous dispersion liquid (Nopco DC-100-A, a trade name, produced by San Nopco, Ltd.) and 7.5 parts by mass of an anionic surfactant (Sunlex NTB-27N, a trade name, produced by Nicca Chemical Co. Ltd.) were added, the addition amount of the thickener was increased by 2.5 times, and the aqueous dispersion liquid was foamed by 1.5 times by mechanical foaming. The foamed film was measured and evaluated for the items (1) to (8) in the same manner as in Example II-1. The results are shown in Table 2.

### Comparative Example II-3

A nonwoven fabric having a foamed film was produced in the same manner as in Example II-1 except that the defoaming treatment, which was performed before coating the aqueous dispersion liquid prepared in Example II-1 on the nonwoven fabric, was not performed, and an aqueous dispersion liquid having a foaming magnification of 1.05 before coating was used. The foamed film was measured and evaluated for the items (1) to (8) in the same manner as in Example II-1. The results are shown in Table 2.

TABLE 2

| | | | | | | | Comparative | Comparative | Comparative |
|---|---|---|---|---|---|---|---|---|---|
| | | Composition | Trade name | Unit | Example II-1 | Example II-2 | Example II-1 | Example II-2 | Example II-3 |
| Composition | (A) | Aqueous | HA-10C | part | 250 | 250 | 250 | 250 | 250 |
| of dispersion | | emulsion resin | | by | solid content: | solid content: | solid content: | solid content: | solid content: |
| liquid | | | | mass | 100 | 100 | 100 | 100 | 100 |
| | (B) | Ammonium | Ammonium | | 5.0 | 5.0 | 5.0 | 5.0 | 5.0 |
| | | salt | sulfate | | | | | | |
| | (C) | Thickener | Kelzan | | 1.5 | 1.5 | 1.5 | 2.5 | 1.5 |
| | (D) | Crosslinking | NK Assist Cl | | 3.75 | 3.75 | 3.75 | 3.75 | 3.75 |
| | | agent | | | | | | | |
| | (E) | Supporting | Matsumoto Microsphere | | 2.0 | — | — | — | 2.0 |
| | | member | F-80SDE | | | | | | |
| | | | (particle diameter: 30 μm | | | | | | |
| | | | Matsumoto Microsphere | | — | 2.0 | — | — | — |
| | | | F-80DE | | | | | | |
| | | | (particle diameter: 100 μm | | | | | | |
| | | | Sunlex NTB27 | | — | — | — | 5.0 | — |
| | | | DC100A | | — | — | — | 7.5 | — |

| Foaming magnification of aqueous dispersion liquid before | | | time | — | — | — | 1.5 | 1.05 |
|---|---|---|---|---|---|---|---|---|
| coating | | | | | | | | |
| Coated amount of dispersion liquid on substrate (wet) | | | g/m² | 800 | 830 | 800 | 830 | 800 |
| Evaluation | (1) | Thickness of film | μm | 580 | 600 | 350 | 550 | 620 |
| items | (2) | Presence or absence of micropores | — | present over | present over | present | none | present over |
| | | on cross section of film | | surface | surface | partially | | surface |
| | | Average pore diameter of large pores | μm | 32 | 110 | -^{(*1)} | 124 | 34 |
| | (3) | Diameter of pinhole on film surface | μm | 3 | 3 | 3 | 21 | 25 |
| | (4) | Density of film | g/cm³ | 0.55 | 0.55 | 0.90 | 0.60 | 0.52 |
| | (5) | Surface roughness of film | μm | 20 | 60 | 20 | 45 | 50 |
| | (6) | Proportion of large pores with | % | 4 | 36 | 0 | 18 | 20 |
| | | diameter exceeding 75 μm to total | | | | | | |
| | | area of cross section of film | | | | | | |
| | (7) | Peeling strength | kg/ | 8.0 | 7.3 | 8.0 | 4.5 | 6.0 |
| | | | 2.5 cm | | | | | |
| | (8) | Transfer property of emboss of skin | — | good | slightly | inferior | inferior | inferior |
| | | pore emboss having convex height | | | good | | | |
| | | of 45 μm and diameter of 20 μm | | | | | | |
| | | Transfer property of emboss of relief | — | good | good | inferior | inferior | inferior |
| | | pattern having convex height of | | | | | | |
| | | 200 μm and diameter of 2 mm | | | | | | |

^{(*1)}Not measurable for no large pore observed

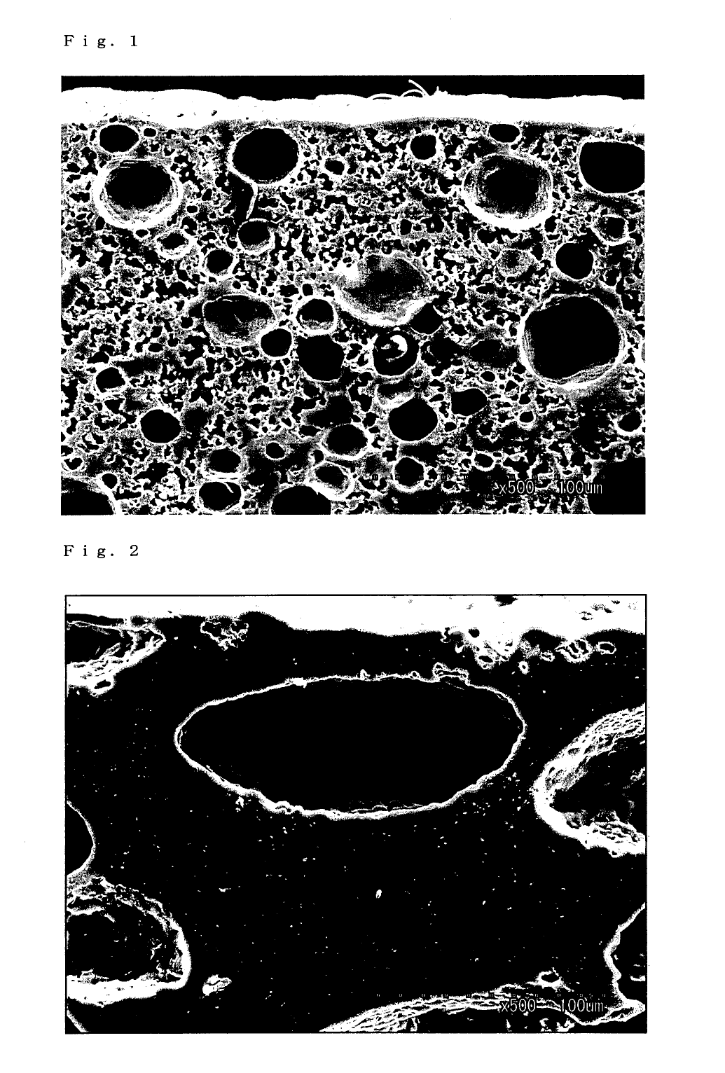

In Example II-1, the foamed capsules were added, and the aqueous dispersion liquid was coated on the substrate after subjecting to the defoaming treatment, followed by gelling, whereby a large number of fine foamed pores were formed on the cross section of the film as shown in the photograph of FIG. 1. The diameter of pinholes on the film surface was small, and a film having a large peeling strength was obtained irrespective of the small density and the light weight thereof. By using the foamed capsules having a particle diameter of 30 μm, good surface roughness was obtained, and good transfer property was obtained even when a fine emboss pattern was used.

In Example II-2, a large number of fine foamed pores were formed on the cross section of the film, the diameter of pinholes on the film surface was small, and a film having a large peeling strength was obtained irrespective of the small density and the light weight thereof. By using the foamed capsules having a particle diameter of 100 μm, the surface roughness was increased, but the emboss transfer property was relatively good.

In Comparative Example II-1, since no supporting member was mixed, the film was solid without fine foamed pores on the cross section of the film, the density thereof was large, and the emboss transfer property was poor.

In Comparative Example II-2, the specific gravity of the film was decreased by mechanical foaming instead of the supporting member mixed. However, as shown in the photograph of FIG. 2, the film was solid without fine foamed pores around the large pores formed by the mechanical foaming on the cross section of the film. The pinhole diameter on the film surface was large, the peeling strength was small, and the emboss transfer property was poor. In particular, since a surfactant was added to the aqueous dispersion liquid, which was then subjected to the mechanical foaming, the peeling strength was consequently deteriorated.

In Comparative Example II-3, since the aqueous dispersion liquid that was not subjected to the defoaming treatment was used, the amount of micropores on the cross section of the film was decreased, the pinhole diameter on the film surface was large, and the emboss transfer property was poor.

### INDUSTRIAL APPLICABILITY

The method for forming a film of the present invention is useful as a production method of a substrate having a film on the surface thereof used for production of a vehicle interior material, furniture, clothing, shoes, bags, bag-like articles, sandals, groceries and the like.

1. A method for forming a film, comprising:
preparing an aqueous dispersion liquid comprising a hydrophilic functional group-comprising resin, an ammonium salt, and a nonionic thickener, wherein a mixed amount of the ammonium salt is from 0.25 to 10 parts by mass per 100 parts by mass of a solid content of the hydrophilic functional group-comprising resin;
coating the aqueous dispersion liquid on a surface of a substrate to form a coated film;
subjecting the coated film to a thermal gelation treatment to form a gelled film; and
drying and solidifying the gelled film to form the film.

2. The method of claim 1, wherein a viscosity of the aqueous dispersion liquid in a period of from preparing to a completion of the thermal gelation treatment is of from 10 to 100 Pa·s.

3. The method of claim 1, wherein the hydrophilic functional group-comprising is a hydrophilic functional group-comprising aqueous emulsion polyurethane resin.

4. The method of claim 1, wherein the thermal gelation treatment is performed with steam at a temperature of from 40 to 140° C.

5. The method of claim 1, wherein the substrate is suitable for an artificial leather.

6. The method of claim 5, wherein the substrate is a hydrothermal extraction type sea-island fiber nonwoven fabric.

7. The method of claim 1, wherein the aqueous dispersion liquid further comprises a crosslinking agent.

8. The method of claim 1, wherein after the preparing, the aqueous dispersion liquid is further subjected to a foaming treatment by a foaming magnification of from 1.1 to 2.5 times.

9. The method of claim 8, wherein the film is a foamed film having a thickness of from 250 to 600 μm and a foam diameter of from 5 to 250 μm.

10. A film that is obtained by the method of claim 1.

11. A film comprising a polymer elastic material, comprising:
a hydrophilic functional group-comprising resin,
a supporting member, and
micropores,
wherein the micropores are formed as gaps among particles of the polymer elastic material after the particles are gelled with a particle form thereof maintained and are partially bonded to each other, and
the supporting member has an average diameter of from 10 to 50 μm being mixedly present on a cross section in a thickness direction of the film,
wherein an opening of the micropores formed on a surface of the film has a pore diameter of 5 μm or less, and
the polymer elastic material has a thickness of from 100 to 800 μm and a density of from 0.40 to 0.90 g/cm³.

12. A film formed by thermal gelation and drying and solidification of polymer elastic material particles formed of a hydrophilic functional group-comprising resin in an emulsion comprising at least the polymer elastic material particles and a supporting member,
wherein the film has micropores formed as gaps among the polymer elastic material particles and the supporting member, which are mixedly present, and
an opening of the micropores formed on a surface of the film has a pore diameter of 5 μm or less.

13. The film of claim 11, wherein the supporting member has a hollow structure.

14. The film of claim 13, wherein the film has pores having an average pore diameter of from 10 to 50 μm on a cross section in a thickness direction of the film, wherein the pores are derived from the supporting member, and an outer wall of the pores has no micropore.

15. The film of claim 11, wherein the polymer elastic material is a hydrophilic functional group-comprising aqueous emulsion polyurethane resin.

16. The film of claim 11, wherein the film has a surface roughness of 30 μm or less.

17. The film of claim 14, wherein a ratio of the pores having a diameter exceeding 75 μm with respect to a total area on the cross section in the thickness direction of the film is 10% or less.

18. A method for forming the film of claim 11, comprising:
preparing an aqueous dispersion liquid comprising a polymer elastic material comprising a hydrophilic functional group-comprising resin, an ammonium salt, a nonionic thickener, and a supporting member,
wherein a mixed amount of the ammonium salt is of from 0.25 to 10 parts by mass per 100 parts by mass of a solid content of the polymer elastic material;
coating the aqueous dispersion liquid on a surface of a substrate to form a coated film;
subjecting the coated film to a thermal gelation treatment to form a gelled film; and
drying and solidifying the gelled film to form the film.

19. The method of claim 18, wherein the aqueous dispersion liquid further comprises a crosslinking agent.

20. The method of claim 18, wherein after the preparing, the aqueous dispersion liquid is further subjected to a defoaming treatment.

21. The method of claim 18, wherein the supporting member is expanded capsules.

22. The method of 18, wherein the supporting member has a size of 50 μm or less.

23. The method of claim 18, wherein a content of the supporting member in the aqueous dispersion liquid is of from 0.2 to 1.5 with respect to a volume of a solid content of the polymer elastic material.

24. A sheet article comprising a substrate and formed thereon the film of claim 11.
